(19) United States
(12) Patent Application Publication
(10) Pub. No.: US 2022/0398668 A1
(43) Pub. Date: Dec. 15, 2022

(54) Relative Measurement System Based on Quantitative Measures of Comparables and Optimized Automated Relative Underwriting Process And Method Thereof

(71) Applicant: Swiss Reinsurance Company Ltd., Zürich (CH)

(72) Inventors: Thomas BLANZ-GILBERT, Zürich (CH); Ashley HIRST, Zürich (CH)

(73) Assignee: Swiss Reinsurance Company Ltd., Zürich (CH)

(21) Appl. No.: 17/821,518

(22) Filed: Aug. 23, 2022

Related U.S. Application Data
(63) Continuation of application No. PCT/EP2021/087608, filed on Dec. 23, 2021.

(30) Foreign Application Priority Data
Dec. 23, 2020 (EP) 2017118.7

(51) Int. Cl. G06Q 40/08; G06Q 40/06

(52) U.S. Cl. CPC G06Q 40/08; G06Q 40/06

(57) ABSTRACT

Proposed is an automated risk assessment and underwriting platform and corresponding method. The platform providing an automated underwriting process comprising the processing steps of: (i) identifying, for each line of business or industry, risk classes with similarity risk characteristics, comprising industry classes and/or sub-classes, (ii) analyzing risk classes for typical risk features, (iii) turning features into a small set of risk focused questions and pre-defined responses from which the underwriting return (UWR) picks the answers, (iv) weighting questions and feeding responses into a structure generating a default risk assessment allocating the actual risk into a risk quality quintile, (v) benchmarking by the underwriter, based on experience and knowledge the actual risk against other bound risks belonging to the same risk class, the underwriter further modifying the default risk assessment leading to a different risk opinion, (vi) justifying with a rationale the modification of the default risk assessment, and (vii) using the final risk assessment as the basis for risk related base rate modifications in the pricing process. Further, the platform provides automated management of risk-driven portfolios.

### CROSS REFERENCE TO RELATED APPLICATIONS

The present application is a continuation application of International Patent Application No. PCT/EP2021/087608, filed Dec. 23, 2021, which is based upon and claims the benefits of priority to European Application No. 20217118.7, filed Dec. 23, 2020. The entire contents of all of the above applications are incorporated herein by reference.

### FIELD OF THE INVENTION

The present invention relates to devices and systems measuring and assessing risks for forthcoming loss-impacting events. In particular, it relates to automated underwriting and risk portfolio management systems and digital platforms, enabling automated underwriting decisions on a consistent, informed and measurable risk assessment. The system not only enables UWR procedure steps to be automated, but also automates and standardized the assessment of individual risks requires the underwriter's knowledge and experience when estimating the quality of an individual risk and benchmarking the risk against similar risks previously written. Finally, the system allows measuring the individual risk's impact on the overall quality of an existing portfolio. It further relates to devices and systems for inter-machine signaling and machine-to-machine control based on the measured probable time to the next upcoming loss events. Finally, it relates to automated risk-transfer systems for time-correlated exposure-based signaling, steering and/or operating of catastrophic risk-event driven or triggered systems; in particular, these can be automated risk-triggered systems and instruments intended to cope with enterprise risks covering a plurality of industry or enterprise branches of lines of business. Beyond that, the invention is further directed to such automated systems capable of self-sustainingly identifying and classifying possible underlying structures that occur at different scales, and using these structures for prediction of the risk event known to arise in an application of interest.

### BACKGROUND OF THE INVENTION

Today, industry need to evaluate their business models around distribution, underwriting, pricing, and risk mitigation to separate from their competitors. Higher loss cost trends in several long-tail lines, and accumulation of losses from recent extreme weather events, are forcing carriers to reassess risk. Increased exposure to catastrophes and competition in personal auto, system and technological upgrades and outlays, medical inflation and social inflation are creating new challenges. Thus, industrial production and business is always a function of risk and return. A decision may either increases, preserves, or erodes value. Given that risk is inherent to any industrial production and business, enterprises are forced to manage risk exposures across all parts of their structure so that to effectively pursue their goals. That's why technical based, reproducible risk assessment and measurement is important, and why insurance carrier or enterprises need to quantify and handle each risk in their structure to the achievement of their overall goals. The term carrier or insurance carrier, as used herein, denotes the physical structure, in particular the infrastructure, enabling a risk-transfer system to absorb the consequences of a physical impact or damage to a real-world object timely and locally (geographically or topographically) exposed to the occurring of a defined physical event. The absorption by the carrier structure requires a prior exchange of resources, the exchanged resource being balanced by the measured future, timely and locally associated (in respect to simultaneousness), probability of the occurrence of the physical event. The carrier structure, i.e. the risk-transfer system, comprises the measuring means and sensors to measure the occurrence of the physical event and/or the physical impact of the occurring event to the real-world object. Further, insurance carrier comprise electronic-based triggers, the triggers measuring physical measuring parameters of occurring events/impacts in loco of the real-world object, wherein by reaching defined threshold values of the measured parameters, an appropriate transfer of resources takes place from the carrier structure to the real-world object being affected by the occurring event. Thus, the term carrier structure or simply carrier, denotes the physical infrastructure enabling to provide a risk-transfer between a physical real-world object and the carrier structure, i.e. the automated risk-transfer, i.e. automated insurance system. Therefore, the terms risk-transfer system and carrier structure, respectively, do not denote the abstract, business-related process of ceding risks between units, as such. Again, in an automated system-environment, thus, a technical based, reproducible risk assessment and measurement is important to ensure a stable long-term operation of the automated risk-transfer system (insurance system). To accomplish this, industry and enterprises require a risk assessment process that is practical, sustainable, and easy to understand. The process must proceed in a structured and reproductional fashion, i.e. based on technical means. It must be correctly sized to the enterprise's size, complexity, and geographic reach. However, enterprise-wide risk management is complex, though automated application techniques have been evolving over the last decade.

On the other hand, generally automated systems, in particular automated risk-transfer systems, and more particularly automated UnderWriting (UW) systems or underwriters (UWR) as such providing technical means for automated risk-transfer based on an insurance process need such reliable and reproducible processes conducted by technical means to technically quantify, technically measure and technically assess (i.e. using technical means as machines, data processing devices etc.) the mentioned risks in industry and enterprises. In the context of this application, risk is understood as a technical and physical quantity, measurable by technical devices in the real world (as sensors, measuring devices etc.) representing the forecasted frequency of occurring physical events with a measurable impact to a defined real world object within a defined future time range to be measured. Further, in the context of this application risk-transfer is understood within this automated technical framework and get induced by the non-technical underlying insurance process only by the technical boundary conditions emerging from the underlying non-technical insurance process, as e.g. country-specific process streamlines and technical calibratable of the used technical means to regulatory boundary conditions. This forecasted physical quantity can be expressed as a probability measuring value, where the measuring is based on real-world measuring values captured by the automated system by measuring devices and real-world sensor at the actual point of time. Risk-transfer systems and risk-transfer underwritings are already traditionally based on assuming risks and/or assessing risks otherwise. However, they face the same problem. While most of the underwriting process steps today can be automated and standardized, the assessment of individual risks requires the underwriter's knowledge and experience when estimating the quality of an individual risk and benchmarking the risk against similar risks previously written. Finally the individual risk's impact on the overall quality of the existing portfolio needs to be quantified and/or assessed otherwise. Risk-transfer on traditional insurance basis means to transfer a certain portion of risk from a property or living object exposed to that risk, in exchange for a premium. The premiums of a plurality of insured properties or living objects lead to an allocation of resources, which in return is used to cover individually occurring losses of the pooled properties and/or living objects which risks have been transferred. Risk-transfer parameters for a specific risk are usually defined as a so called policy, where the policyholder is liable for transferring the premiums, and is on the other side enabled to receive the loss coverage in case of an occurring loss. Insurance systems need to decide which risks to assume based on probabilities. Insurance systems typically operate by insuring a large number of policyholders with similar characteristics and thus a controllable and/or assessable probability of generating losses. Technically, to remain operatable, a risk-transfer system must be selective about the types of risks it assumes. Otherwise, it could be forced to transfer more resources, e.g. monetary resources, to cover occurring losses than it collects or pooled in premiums. If its pooled resources do not cover the shortfall, the insurance system could become corrupted. Each insurance system can decide what types of risks it wants to transfer and what coverages it wants to apply. Once the risk-transfer structure and strategy is defined, the insurance system is able to create underwriting rules. Potential underwriters must follow these rules when selecting applications and/or renewing policies.

Different technical frameworks are known for assessing and quantifying individual and/or collective risks, i.e. measuring the probability of the occurrence of a measurable loss event to a property and/or living object and/or accumulating the different risks over the whole industrial structure or business branch. In the prior art, risk assessment follows event identification and precedes risk response. Its purpose is to measure or otherwise access how big the risks are, both individually and collectively, in order to enable the insurance carrier or enterprise to handle the most important threats and opportunities, and to lay the groundwork for risk response. Risk assessment is all about measuring and prioritizing risks so that risk levels are managed within defined tolerance thresholds, i.e. without being overcontrolled or blocking workflow or development. Events that may trigger risk assessment may also include the need for an establishment of automatic surveillance, periodic refreshes, starts of new projects, mergers, acquisitions, or restructuring. Risks can be dynamic and require continual ongoing monitoring and assessment, such as certain production risks. Other risks are more static and require reassessment on a periodic basis with ongoing monitoring triggering an alert to reassess sooner should circumstances change.

Typically, a risk (or event) identification process precedes risk assessment and may result in a defined list of risks, e.g. organized by risk category (financial, operational, strategic, compliance) and/or sub-category (market, credit, liquidity, etc.) for industry or business units, corporate functions, and capital projects. At this stage, a wide net is cast to understand the universe of risks making up the insurance carrier's or enterprise's risk profile. The term enterprise, as used herein, includes insurance carrier's or other risk carriers and risk-exposed enterprises. While each risk captured may be important to management at the function and business unit level, the list requires prioritization to focus attention on or filter key risks. Also this prioritization is accomplished by performing the risk assessment. To create a risk assessment process, the first step within the risk assessment process normally involves developing a common set of assessment or trigger criteria to be deployed across the industrial or business units, corporate functions, and large projects. Risks are typically assessed in terms of measuring its impact and its likelihood, as a probability measure. Some prior art systems, in addition, comprise means for measuring and assessing risks along additional dimensions such as vulnerability measures and speed of onset measures.

Technically, assessing risks consists of measuring and assigning physical quantity values to each risk, i.e. the physically measurable quantity for the probability for an impacting event or using the defined criteria. This may be accomplished in two stages where an initial screening of the risks is performed using qualitative techniques followed by quantitative measurements of the most important risks. Risks do not exist in isolation, thus assessing risks normally also involves assess risk interactions. Due to possibly non-linear dependencies, even seemingly insignificant risks on their own have the potential, as they interact with other events and conditions, to cause great measurable impacts. Therefore, many prior art systems try to provide an integrated or holistic approach to risk measures using techniques such as risk interaction matrices, bow-tie diagrams, and aggregated probability distributions. Many prior art systems also involve the additional process step of risk prioritization for determining risk by comparing the level of measured risks against predetermined target risk levels and tolerance thresholds. Risk may be assessed not just in terms of impact and probability measures, but also subjective criteria such as health and safety impact, reputational impact, vulnerability, and speed of onset. The results of the risk assessment process then may be used for generating appropriate risk-transfer parameters and/or as the primary input to expert systems for providing automated risk responses whereby response options can be examined (accept, reduce, share, or avoid), cost-benefit analyses performed, a response strategy formulated, and risk response plans developed.

In summary, there is a need to extend prior art systems underwriting automation to be based on a dedicated relative risk measuring and assessment process with a differentiated technical approach—providing more efficient, reliable, and better automatically priceable experience, based on the provided relative portfolio underwriting.

### SUMMARY OF THE INVENTION

It is one object of the present invention to provide an automated risk measuring and assessment system together with an automated underwriting structure to different sized segments of enterprises. The system should be enabled to provide a more efficient, reliable engine with better priceable risk-transfers, based on standardized policy wording and model-based relative portfolio underwriting. The system should be enabled to tackle the challenges and disadvantages of noise and bias in the prior art automated underwriting processes and systems, and make the technical structure and used technical means of underwriting more effective. It should also provide a much better, truly end to end way of managing enterprise risks and risk-transfer portfolios providing in addition a more transparent approach, so that clients and brokers will experience a step-change in quality of experience. The invention should provide a method and corresponding technology platform that support relative portfolio underwriting. Among others, the invention should be also capable of providing an automated system for measuring, predicting and exposure-signaling for associated automated risk-transfer systems driven by different frequencies of operational, catastrophic or other risk events, which does not suffer from the disadvantages of the prior art systems, as discussed above. The output signaling should also allow for providing automated risk-transfer systems in order to optimize resource-pooling (capitalization).

According to the present invention, these objects are achieved, particularly, with the features of the independent claims. In addition, further advantageous embodiments can be derived from the dependent claims and the related descriptions.

According to the present invention, the above-mentioned objects for an automatedly optimizing risk assessment and optimizing portfolio management system for an automated underwriting platforms of line of business risks, as e.g. general liability and professional liability (PL), worker compensation and employers' liability (EL), and property risks, based on relative risk measurements are achieved by an automated underwriting process bring at least based upon the steps of risk identification and risk classification and risk assessment, wherein a portfolio is a risk transfer pool or appropriate risk-transfer accumulation structure capable of holding or capturing a plurality risk-transfers interlinked by a mutual relationship provided by the portfolio, and wherein a risk-transfer captures at least a part of a risk associated with an underwriter, characterized by the processing steps of: (A) identifying risk classes or cohorts of risk-transfers in the portfolio, wherein each risk class or risk cohort of the portfolio comprises risk-transfers having defined risk characteristics parameter values in a class-specific risk parameter value range associated with a risk class or cohort, and wherein each of the risk classes or cohorts of the portfolio is associated with a class-specific risk exposure parameter range, (B) detecting and assigning for a new risk-transfer to be added to the portfolio a risk class or risk cohort of the portfolio by triggering the risk class or risk cohort based on the risk characteristics parameter values of the risk-transfer to be added, the risk characteristics parameter values of the risk-transfer being in the class-specific risk exposure parameter range of the triggered risk class or risk cohort, (C) assessing a relative risk measure based on the actual risk exposure associated with the newly to be added risk-transfer, the relative risk measure measuring the association between the total risk exposure and an actual portfolio-specific outcome upon adding the new risk-transfer, and (D) adding the newly to be added risk-transfer to the portfolio, if the relative risk measure is within a desired value range.

In an embodiment variant, automated risk assessment and underwriting platform comprises the further processing steps of: (i) identifying, for each line of business and industry, risk classes with similar risk characteristics, comprising industry classes and/or sub-classes, (ii) analyzing risk classes for typical risk features, (iii) turning features into a small set of risk focused questions and pre-defined responses from which the underwriter (UWR) picks the answers, (iv) weighting questions and feeding responses into a structure generating a default risk assessment allocating the actual risk into a risk quality quintile, (v) benchmarking by the underwriter, based on experience and knowledge the actual risk against other bound risks belonging to the same risk class, the underwriter further modifying the default risk assessment leading to a different risk opinion, (vi) justifying with a rationale the modification of the default risk assessment, and (vii) using the final risk assessment as the basis for risk related base rate modifications in the pricing process. The selection of comparables can also be more complex and can include amongst other criteria the same risk class and/or PIC3 and/or NAICS and/or GDV code etc.

In one alternative embodiment, the system comprises means for processing risk-related component data of the risk-transfer and/or underwriter and/or risk-exposed units and for providing information regarding the likelihood of said risk exposure to become realized for one or a plurality of the pooled risk-exposed units or individuals, in particular, based on risk-related data concerning risk-exposed units or individuals, wherein a receipt and preconditioned storage of payments from a first resource pooling system to a second resource pooling system for the transfer of its risk can be determined dynamically based on the total risk and/or the likelihood of risk exposure of the pooled risk-transfers. This alternative embodiment has, inter alia, the advantage that the operation of the first and/or second risk-transfer systems with first and second resource pooling system can be dynamically adjusted to the changing conditions of the pooled risk, such as changes in the environmental conditions or risk distribution, or the like, of the pooled risk components. A further advantage is the fact that the system does not require any manual adjustments, if it is operated in different environments, places or countries, because the size of the payments of the risk-exposure components is directly related to the total pooled risk.

In one alternative embodiment, the number of pooled risk-transfers of a portfolio can be dynamically adjusted via the first risk-transfer system to a range where non-covariant, occurring risks that are covered by the risk-transfer system affect only a relatively small proportion of the total pooled risk-exposure components at any given time. Analogously, the second risk-transfer system can, for example, dynamically adjust the number of pooled risk shares transferred from first risk-transfer systems to a range, where non-covariant, occurring risks that are covered by the second risk-transfer system affect only a relatively small proportion of the total pooled risk transfers from first risk-transfer systems at any given time. This variant has, inter alia, the advantage that it allows for improving the operational and financial stability of the system.

In one alternative embodiment, the risk event triggers are dynamically adjusted by means of an operating module based on time-correlated incidence data relative to one or a plurality of the predefined risk events. This alternative embodiment has, inter alia, the advantage that it allows for improving the capture of risk events or for avoiding the occurrence of such events altogether, for example, by improved forecasting systems, etc., to dynamically capture such events by means of the system and dynamically affecting the overall operation of the system based on the total risk of the pooled risk-exposure components.

In another alternative embodiment, upon each triggering of an occurrence, where parameters indicating a predefined risk event are measured by means of at least one risk event trigger, a total parametric payment is allocated with the triggering, and wherein the total allocated payment is transferrable upon a triggering of the occurrence. The predefined total payments can, for example, be leveled to any appropriate, defined total sum, such as a predefined value, or any other sum related to the total transferred risk and the amount of the periodic payments of the risk-exposed motor vehicle. This alternative has, inter alia, the advantage that, for the parametric payments or the payments of predefined amounts, the user can rely on fixed amounts. Further, the parametric payment may allow for an adjusted payment of the total sum that can, for example, depend on the stage of the occurrence of a risk event, as triggered by the system.

### BRIEF DESCRIPTION OF THE DRAWINGS

The present invention will be explained in more detail below relying on examples and with reference to these drawings in which:

FIG. 1 shows a block diagram schematically illustrating an exemplary automated system and method providing individual risk assessment and relative portfolio underwriting based on relative risk assessment and pricing. In particular, FIG. 1 shows the UW decision process based on the inventive relative risk assessment process and price comparison process, provided by the inventive portfolio impact monitoring.

FIG. 2 shows a block diagram schematically illustrating an exemplary process of an underwriting process establishing risk quality assessment for a new submission of a risk-transfer to be added to the portfolio.

FIG. 3 shows a block diagram schematically illustrating an exemplary underwriting process, where the underwriter negotiates price within rate filing range, and makes go/no-go decision with reference to costing and portfolio impact.

FIG. 4 shows a block diagram, schematically illustrating an automated, risk assessing/measuring and underwriting system according to the invention providing an end-to-end (E2E) underwriting process and risk management chain.

FIG. 5 shows a block diagram schematically illustrating an exemplary overview capturing the complete automated underwriting process and optimized portfolio management.

FIGS. 6 and 7 show a diagram schematically illustrating an exemplary overview of usable classification rules, Lines of Business or Industry (LoB) classification, and geo-Classification. Both tables exemplarily show different parameters for selecting comparables.

FIGS. 8A and 8B show a diagram schematically illustrating exemplary matching and triggering rules for identifying comparables for providing a Minimum Viable Product (MVP). This is a list of parameter selection rules for comparables providing a possible list of parameters per (Line of Business) LoB and region.

FIG. 9 shows a diagram schematically illustrating exemplary an automated UW decision process based on an automated machine-based relative risk assessment and pricing parameter matching for automated price comparison and optimization. FIG. 9 is based on a calibration relying on boundaries condition for the EMA region (Europe, the Middle East and Africa). The upper part of FIG. 9 lying above the horizontal line shows the automated portfolio impact measuring and monitoring, while the lower part of FIG. 9 below the horizontal line shows the automated UW workflow and decision-process-flow. The automated risk measuring and risk assessment can e.g. comprise the steps of (i) risk classes with similar risk characteristics are defined, (ii) the risk class defined by common risk feature parameters, (iii) the risk features are automatedly transferred into risk questions and pre-defined responses by selecting them from a set based on the feature parameters, (iv) responses are captured, wherein the response values and parameters generate the risk quality score which places a measured or determined risk into a risk quintiles, (v) the actual risk is benchmarked by underwriter systems against historical risks of same risk class, (vi) underwriter refining risk opinion and modifies risk score are refined by linking it to underwriter systems which leads to final risk quintile for placement of risk, (vii) as a variant manual modification may be applied justified with rationale, (viii) the final risk score can be applied for rate modifications (debits/credits). The automated portfolio management comprises the steps of (i) automated performance monitoring in financial and risk quality terms, (ii) defining targets per risk class and expected risk quality, (iii) immediate tracking of risk quality and price strength for impact of single risk on portfolio performance and quality during underwriting process, (iv) measuring/capturing additional operational and risk related key performance measures comprising (1) making modifications to default risk scores (based on captured questions/responses parameters), (2) automated tracking of unanswered questions, (3) optionally, an average risk quality per segment is measured against financial performance, (4) connecting risk questions/responses with actual claims experience, and (v) making applied risk questions, responses and weightings subject to frequent validation.

FIG. 10 shows a diagram schematically illustrating exemplary an automated UW decision process based on an automated machine-based relative risk assessment and pricing parameter matching for automated price comparison and optimization. FIG. 10 is based on a calibration relying on boundaries condition for the region of the United States. The automated pricing process in the US must meet specific regulatory requirements (resulting in corresponding boundary condition parameter values), which doesn't allow to make use of the risk score in the same way, it is done in EMEA (for the EMEA process see FIG. 9). While the risk score generated at the end of the benchmark process is directly applied as a base rate modifier the risk score in the US is only used to move the risk actually been underwritten into the respective risk quintile. The automated application of the risk quality for pricing purposes takes place in 2 steps: (1) Each State allows applying rate modifiers within a defined range of percentages (debits/credits). The range differs by State. In the example shown here, a range was chosen from −25% (maximum credit) to +25% (maximum debit). This state defined range has been divided into 5 sectors as shown in the graphic. For applying the factor to be used for modifying the class rates (equivalent to base rates in EMEA), the mean value of the sector which equals the risk quintile is taken. The better the risk quality and the quintile to which the risk has been allocated, the higher the discount and vice versa—the worse the risk/quintile the higher the debit. In this example, the value on which the factor is based upon is −10% (average of −15% and −5%) which translates into a factor of 0.9 to be applied. The premium derived this way is considered to the technical premium or in system terms the original premium. There are different terms been used for the premium derived like that but this doesn't impact the concept of the US UW approach. Technical premium reflects 100% price strength similar to the EMEA approach where a LTPA concept (Long Term Premium Adequacy) is applied; (2) In a second step the UW can modify the technical premium by applying debits and credits to specific risk features or modifiers which have been filed with the regulators. The number and the nature of these modifiers vary by line of business. The result of applying the modifiers leads to the so-called adjusted premium and to a different price strength either below or above 100%.

FIG. 11 shows a diagram schematically illustrating exemplary an automated UW decision process based on an automated machine-based relative risk assessment and pricing parameter matching for automated price comparison and optimization having exemplarily three possible modifiers completed. Again, FIG. 11 (as FIG. 10) is based on a calibration relying on boundaries condition for the region of the United States. In order to apply these modifiers, the range of debits/credits is limited based on the risk quintile the risk has been originally allocated to: (i) the maximum debit is the state mandated percentage in this case +25%; (ii) the maximum credit is defined by the maximum percentage of the risk quintile in the present case −15%.

In the following 3 figures (FIGS. 12/13/14), 3 exemplary different modifiers were completed and illustrated.

FIG. 12 shows a diagram schematically illustrating exemplary an automated UW decision process based on an automated machine-based relative risk assessment and pricing parameter matching for automated price comparison and optimization having the exemplarily first modifier completed. The exemplary modifier 1 allows the UWR to automatedly measure and evaluate quantitatively the quality of the insured's risk management. In the present case, the UWR considers the risk management to be on the lower end of “average” and selects a debit of +5%. The application of the modifier seem like a duplication of the risk assessment questions which is actually the case. However, this approach is the only way to apply risk quality scores without violating regulatory requirements and boundary conditions. From a US regulatory view, changes to the premium level based on risk quality considerations are considered deviations from the technical premium.

FIG. 13 shows a diagram schematically illustrating exemplary an automated UW decision process based on an automated machine-based relative risk assessment and pricing parameter matching for automated price comparison and optimization having the exemplarily second modifier completed. The exemplary modifier 2 allows the UWR to automatedly evaluate the quality of the insured's building & equipment. In the present case, the UWR considers building & equipment to be on the lower end of “fair” and selects a debit of +15%

FIG. 14 shows a diagram schematically illustrating exemplary an automated UW decision process based on an automated machine-based relative risk assessment and pricing parameter matching for automated price comparison and optimization having the exemplarily third modifier completed. The exemplary modifier 3 allows the UWR to evaluate the quality of the insured's location. In the present case, the UWR considers the location to be on the higher end of “good” and selects a credit of −15%.

FIG. 15 shows a diagram schematically illustrating exemplary an automated UW decision process based on an automated machine-based relative risk assessment and pricing parameter matching for automated price comparison and optimization having the exemplarily modifiers completed. The summary of the values of all 3 modifications is in FIG. 15 applied as the final debit/credit parameters. The percentages are transferred into a factor to be multiplied with the technical/original premium amount. In the present case, the total value is a debit of +5%.

FIG. 16 shows a diagram schematically illustrating exemplary an automated UW decision process based on an automated machine-based relative risk assessment and pricing parameter matching for automated price comparison and optimization having the exemplarily modifiers completed. As FIG. 16 shows, the automated pricing strength, in the present case, has changed and optimized from 100% to 105%. The automated risk measuring and risk assessment can e.g. comprise the steps of: (i) risk classes with similar risk characteristics are defined, (ii) the risk class defined by common risk feature parameters, (iii) the risk features are automatedly transferred into risk questions and pre-defined responses by selecting them from a set based on the feature parameters, (iv) responses are captured, wherein the response values and parameters generate the risk quality score which places a measured or determined risk into a risk quintiles, (v) the actual risk is benchmarked by underwriter systems against historical risks of same risk class, (vi) underwriter refining risk opinion and modifies risk score are refined by linking it to underwriter systems which leads to final risk quintile for placement of risk, (vii) as a variant manual modification may be applied justified with rationale, (viii) the final risk score can be applied for defining the % range within the allowed State range of debits/credits. The automated portfolio management can e.g. comprise the steps of (i) automated performance monitoring in financial and risk quality terms, (ii) defining targets per risk class and expected risk quality, (iii) immediate tracking of risk quality and price strength for impact of single risk on portfolio performance and quality during underwriting process, (iv) measuring/capturing additional operational and risk related key performance measures comprising (1) making modifications to default risk scores (based on captured questions/responses parameters), (2) automated tracking of unanswered questions, (3) optionally, an average risk quality per segment is measured against financial performance, (4) connecting risk questions/responses with actual claims experience, and (v) making applied risk questions, responses and weightings subject to frequent validation.

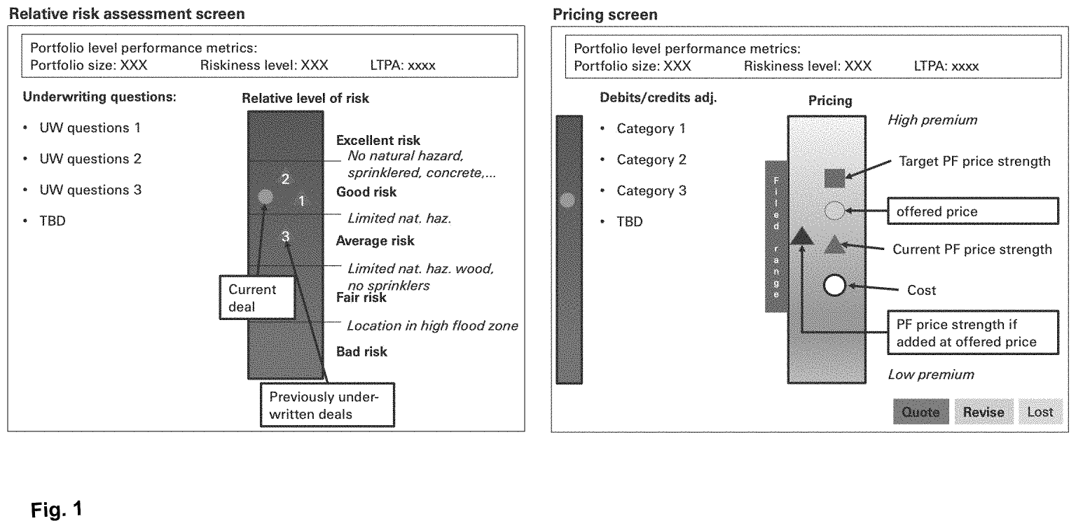

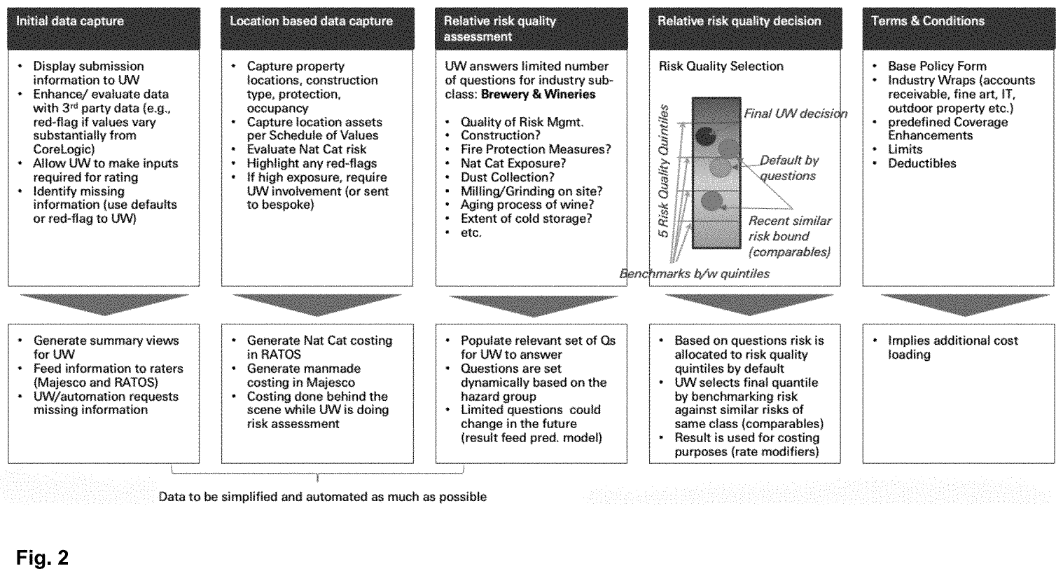

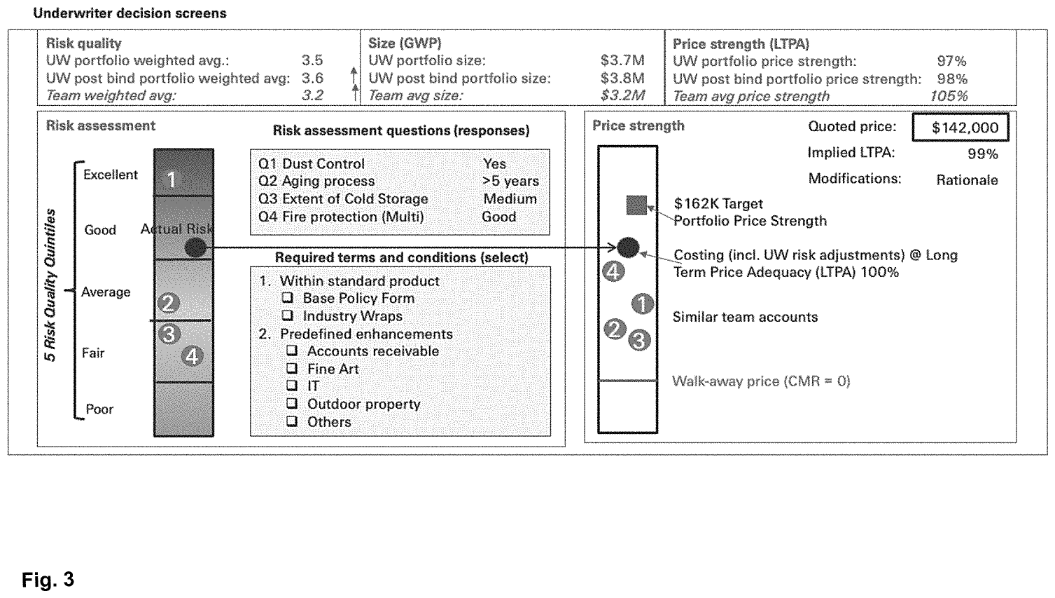

### DETAILED DESCRIPTION OF THE PREFERRED EMBODIMENTS

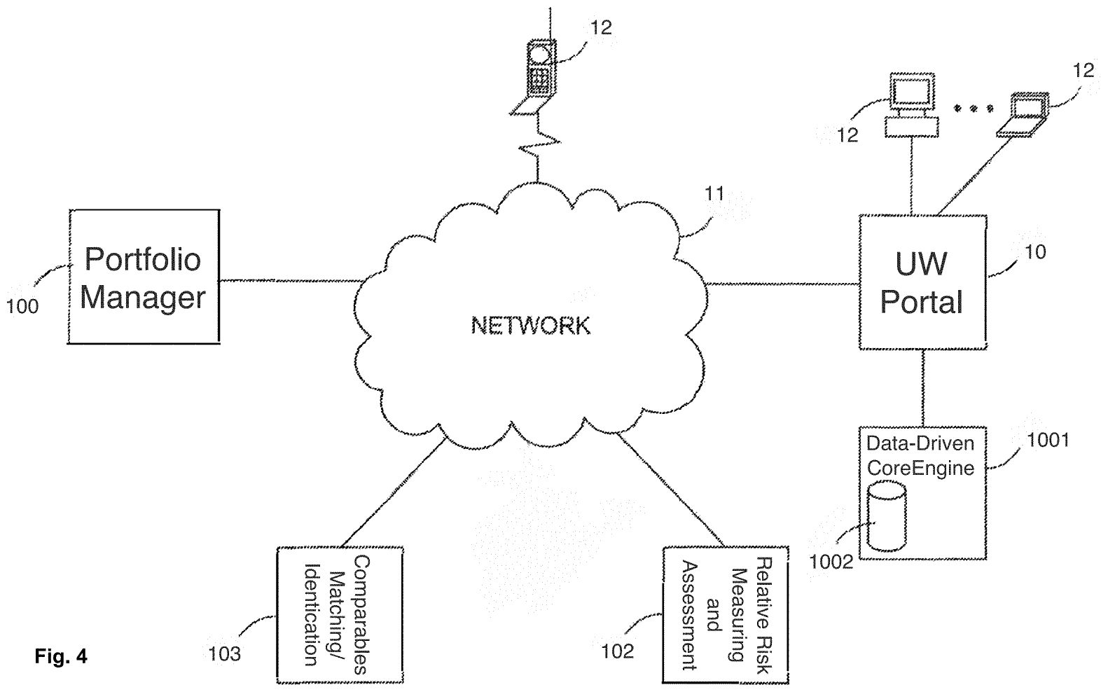

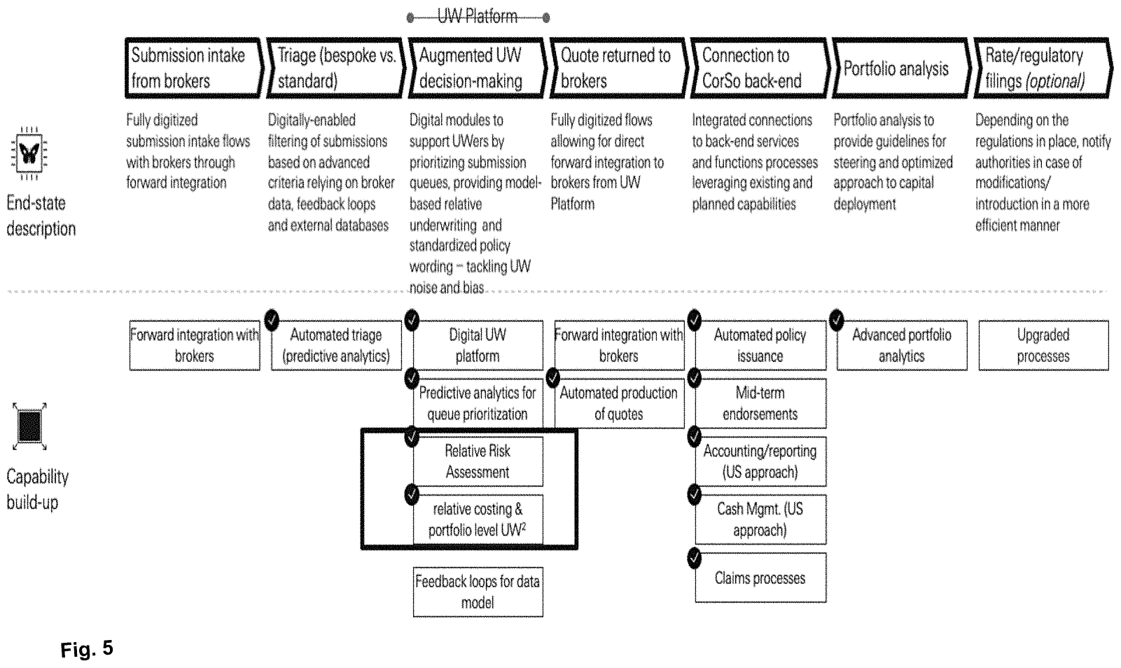

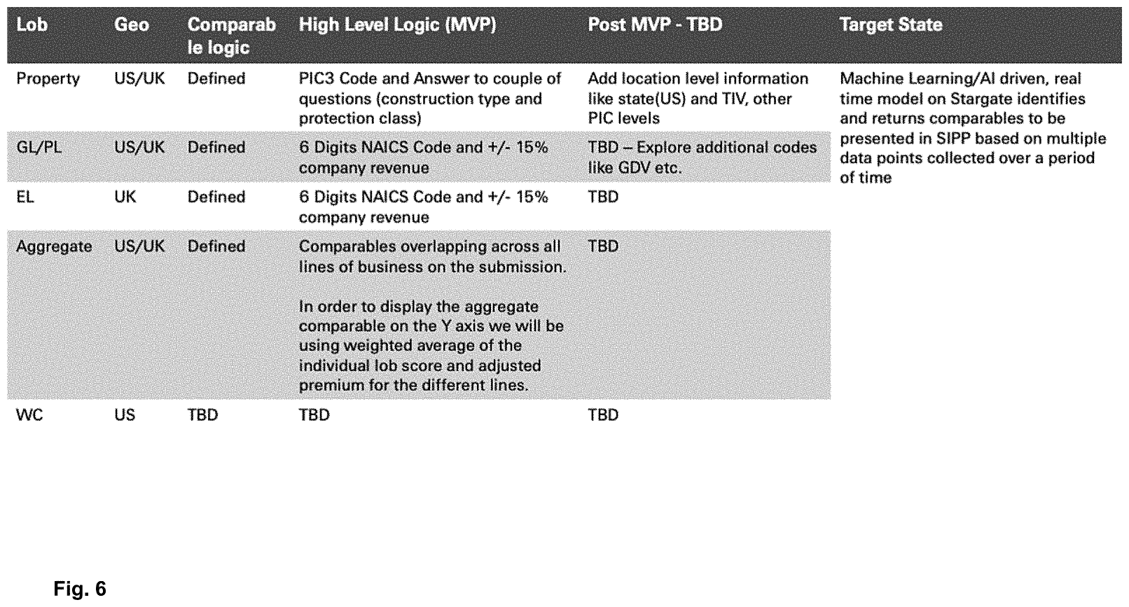

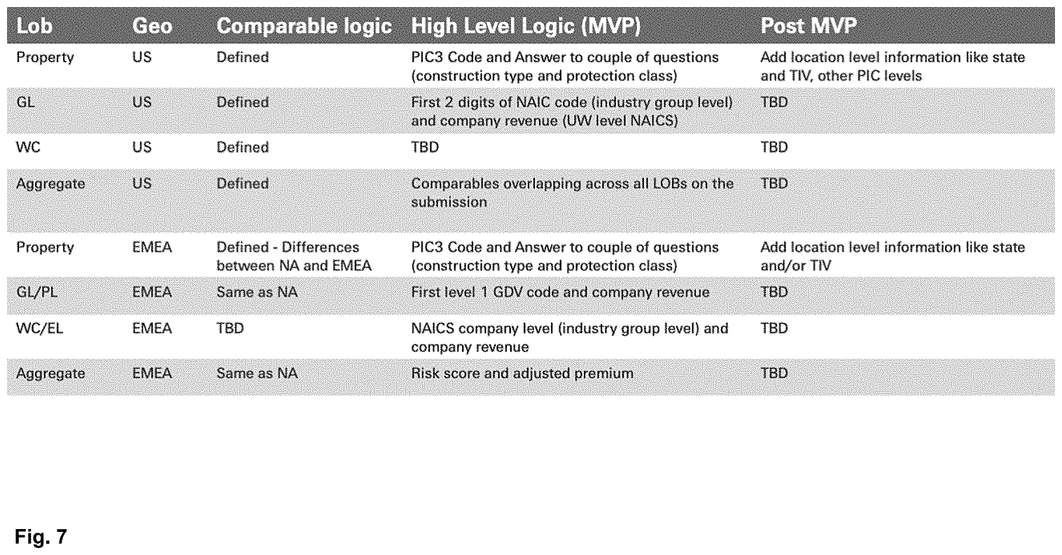

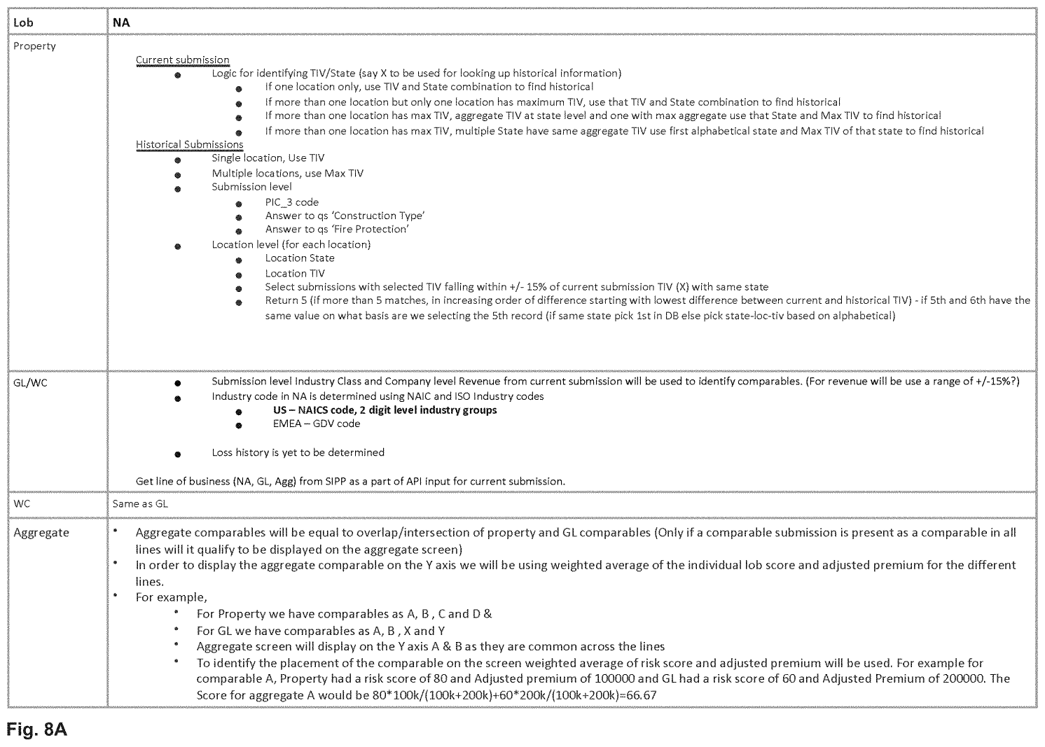

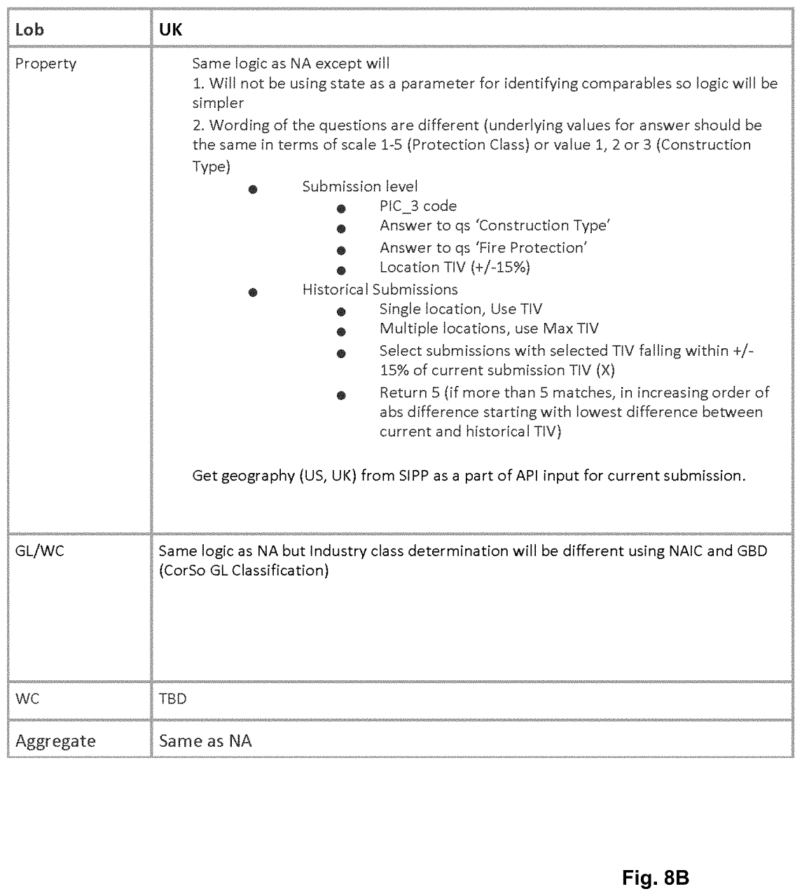

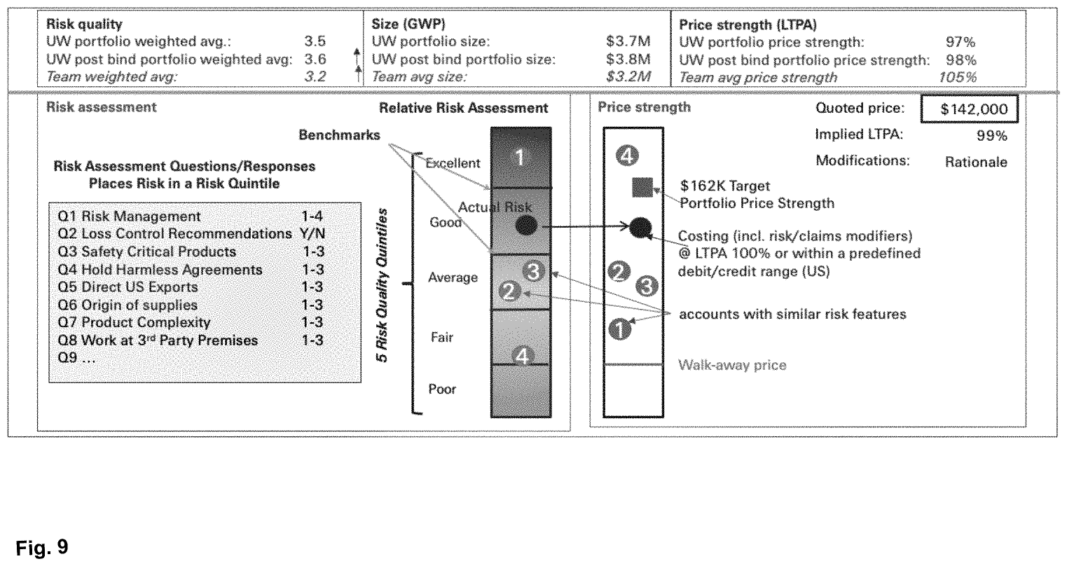

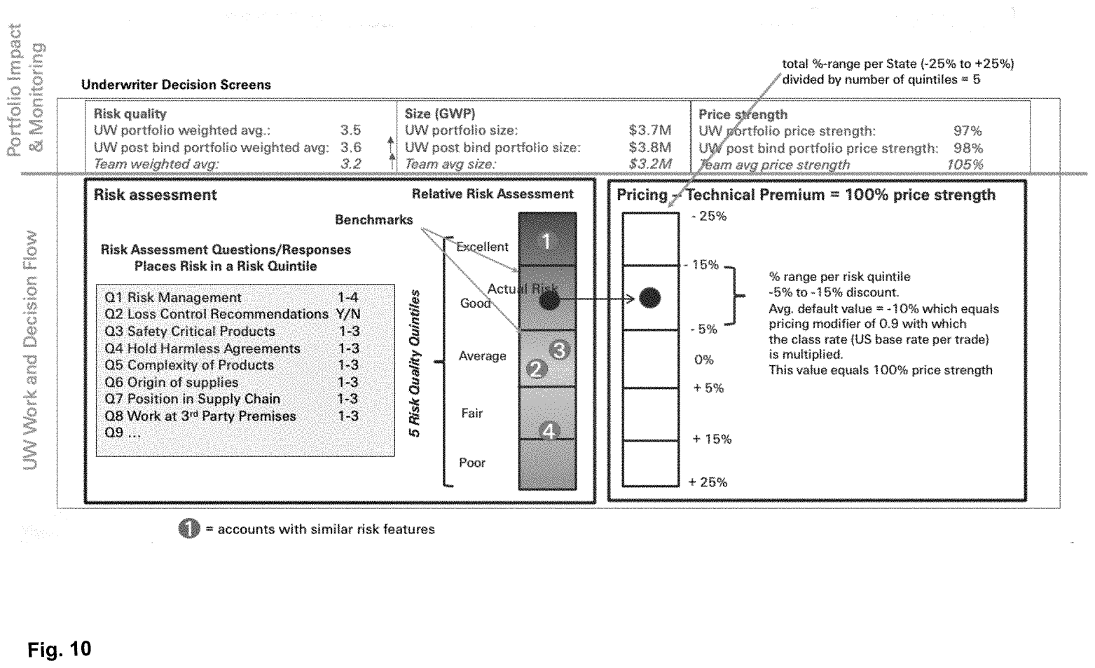

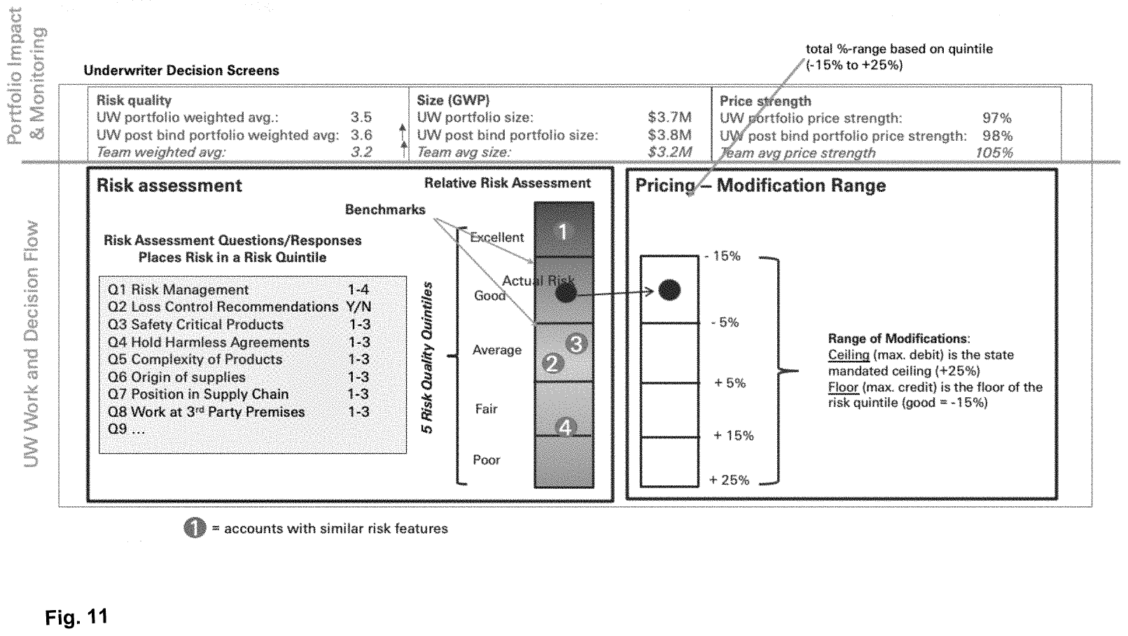

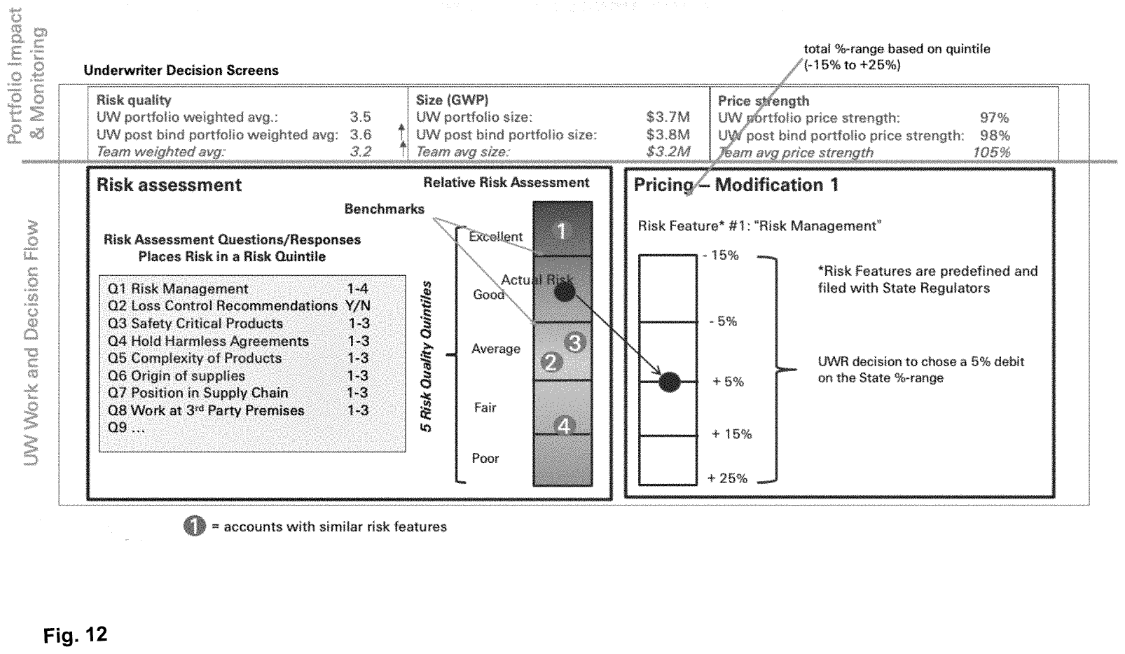

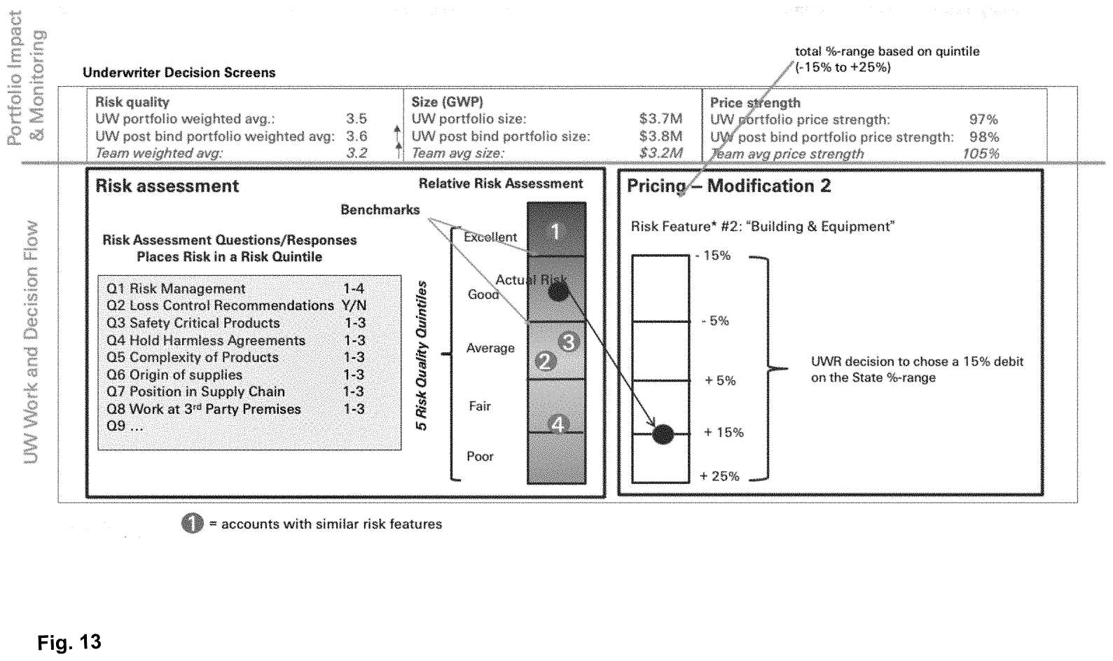

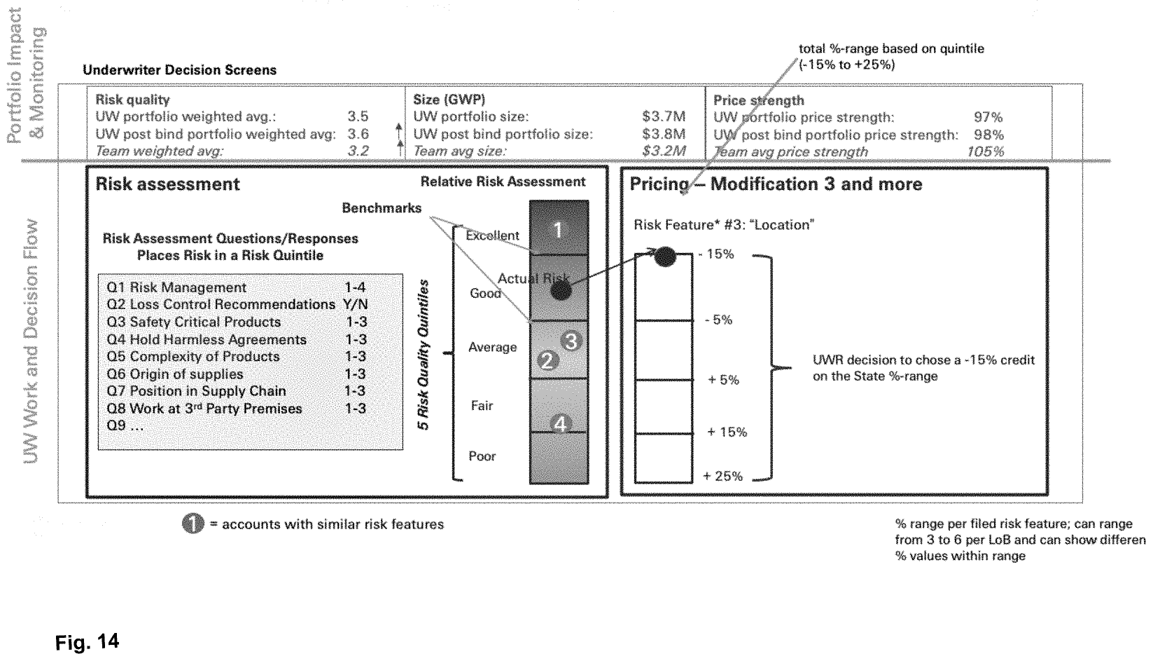

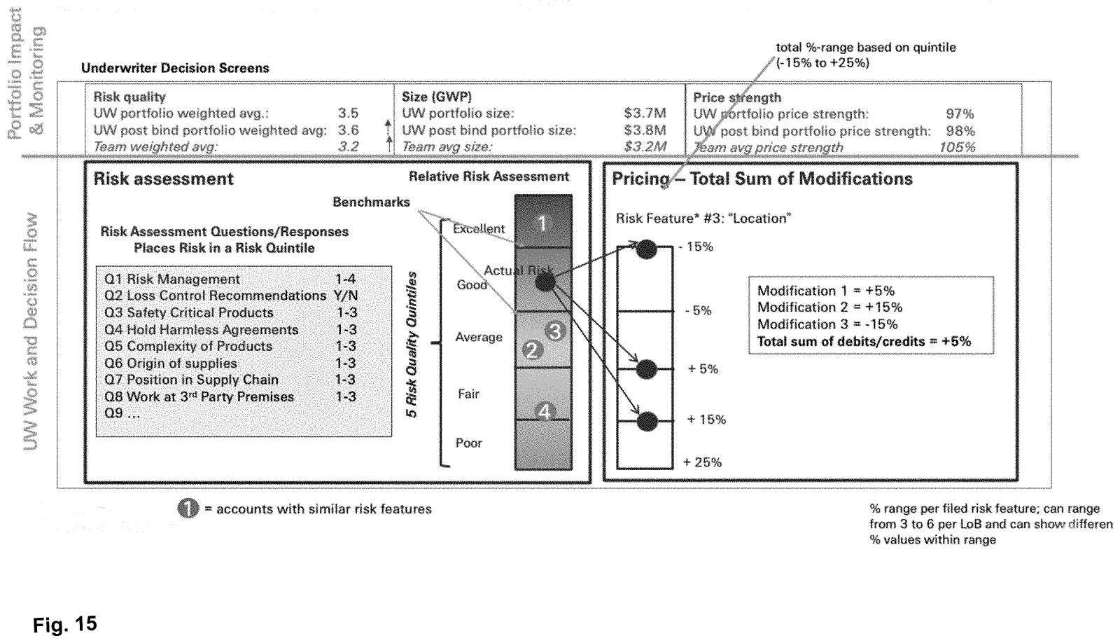

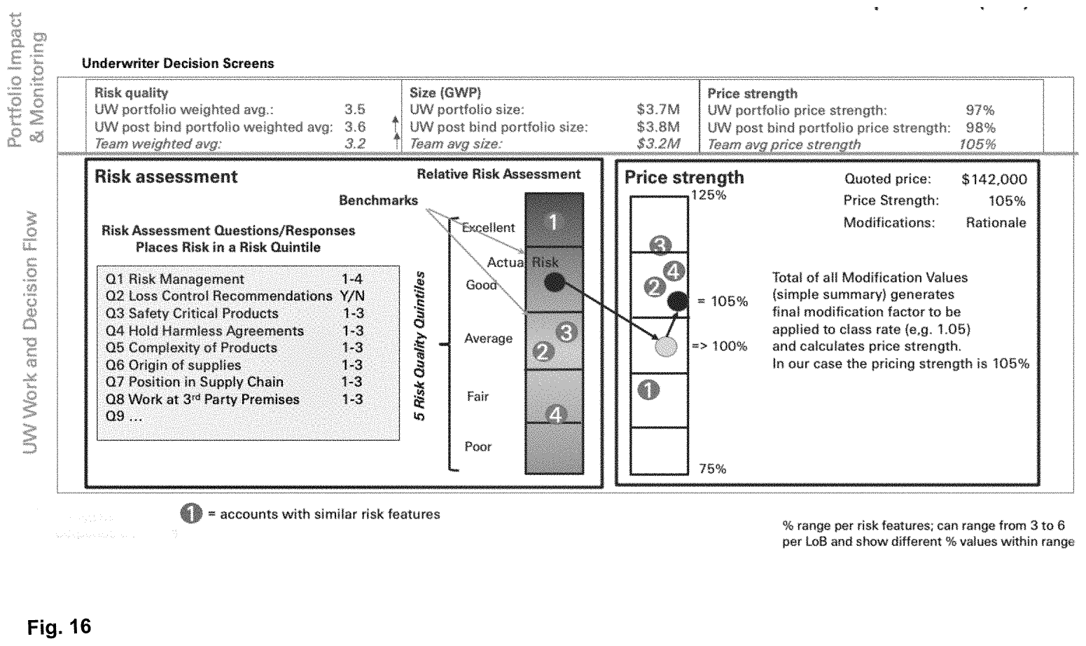

FIG. 4 schematically illustrates an architecture for an automated risk assessment, portfolio management and underwriting platform 10 and overall system 1 according to the invention. The automatedly optimizing risk assessment and optimizing portfolio management system 1 provides an automated underwriting platform 10 for risk-transfers of line of business risks, as e.g. general liability and professional liability (PL), worker compensation and employers' liability (EL), and property risks, based on relative risk measurements. The system 1 comprises an automated underwriting process 1001 being at least based upon the steps of risk identification and risk classification and risk assessment. A portfolio 10021, as used herein, is a container, e.g. comprising an appropriate data structure, capturing a plurality risk-transfers 10022 interlinked by a mutual relationship provided by the portfolio 10021. A risk-transfer 10022 is a structure for capturing at least a part of a risk associated with an underwriter 13 of a risk-exposed unit exposed to line of business risks, as e.g. general liability and professional liability (PL), worker compensation and employers' liability (EL), and property risks. The processing steps comprise:

(A) Assigning industry code: Identifying risk classes or cohorts 10023 of risk-transfers 10022 in the portfolio 10021. Each risk class or risk cohort of the portfolio 10023 comprises risk-transfers 10022 having defined risk characteristics parameter values 100220 in a class-specific risk parameter value range 100231 associated with a risk class or cohort 10023. Each of the risk classes or cohorts 10023 of the portfolio 10021 is associated with a class-specific risk exposure parameter range 100232. The risk groups or cohorts 10023 can e.g. be automatically classified by applying internal risk codes and/or external industry codes. The applied internal risk codes at least can e.g. comprise Property Industry Code (PIC) risk identification for property risks. The external industry codes at least can e.g. comprise North American Industry Classification System (NAICS) and/or German Insurance Association (GDV) classification. In case of detecting a lack in granular risk information provided by the captured risk characteristics parameter values by means of the system, more granular risk classes or cohorts 10023 can e.g. be automatically grouped high level groups or cohorts 10023.

(B) Assigning risk and risk score based on risk question sets: Detecting and assigning fora new risk-transfer 100221 to be added to the portfolio 10021, a risk class or risk cohort 10023 of the portfolio 10021 is triggered based on the risk characteristics parameter values 100220 of the risk-transfer 100221 to be added. The risk characteristics parameter values 100220 of the risk-transfer 100221 is in the class-specific risk exposure parameter range 100232 of the triggered risk class or risk cohort 10023.

For the automated identification of risk classes or cohorts 10023 of risk-transfers 10022, prior art systems on risk pre-warning and pre-control, in particular related to e.g. general liability and professional liability (PL), worker compensation and employers' liability (EL), and property risk, typically focus on the linear causal relationship between risk and risk events. In fact, risk events in the risk-transfer technology field are often caused by multiple risk factors, which are directly or indirectly related to these risk factors. Therefore, it can be advantageous to filter the related risks of each possibly occurring risk event and screen and control them one by one. As an embodiment variant, the present system can be realized using an automated, ontological-based classification by constructing and generating a line-of-business risk ontology model structure. This structure is adapted to the variability, complexity and relevance of risk in early warning and pre-control. Then, based on risk source association inference rules obtained by knowledge association analysis, an apriori algorithm is adopted to conduct association analysis on a risk hidden danger database. The thus acquired association rules are reintroduced into the knowledge ontology database of risk event source to realize self-learning and self-correction of the knowledge ontology database. Measuring a physical real-world risk event impacting the exposed real-world object, the usage of the selected and/or generated risk ontology model structure can be calibrated. Again, if in classification, occurring risk events are treated as independent events, that is, one risk source corresponds to one occurring risk event, this leaves out a possible correlation of risk event occurrence causes. In this way, only the risk sources of risk events can be effectively controlled, and the potential risk sources cannot be identified or classified. However, in reality, occurring risk events are often caused by the correlation of multiple risk factors. These risk factors, as a system structure, interact with each other at different times and places in different order, covering the whole process of the impacting risk event. In addition, in the whole process of risk control, whether it is pre-control or post-event emergency treatment, risks may arise and lead to the escalation of the impacts of a risk event. So many risks create a chain of events, with impacts and losses at the end of the chain. This makes classification technically challenging.

The ontological structure is used herein as an identifier of the sources and as a technical mean for knowledge abstraction and description. It can consist of five elements: concept, relationship, instance, function and axiom, where concept denotes a model structure enabled to describe the exposed real-world object or risk event providing easy machine understanding and operation, and relationship denotes the weighted link between the concepts and a class, i.e. its class association, and instance is the basic element of the concept giving the instantiation of a concrete example, and function is the definition of the method, and axiom is a recognized factor or inference rule. Constructing/generating the ontological structure of a line-of-business risk, the used risk ontology framework can mainly consist of three parts: Class, Property and Individual: (1) A class is an abstraction of a collection of objects in the real world, representing a collection of individuals with common attributes; (2) Property: attributes generally represent the relationship between classes and classes, mainly including object characteristics and data characteristics; (3) An individual is a concrete object of a class, mainly for an abstract description of a concrete object that is an individual layer. The present invention can e.g. have two main types of characteristics' factors: object characteristics and data characteristics, in which object characteristics are usually used to represent the relationship between classes, and data characteristics are usually used to represent the data characteristics of each class.

Further, the mentioned risk association inference rules describe the correlation between risk sources indexed by risk event scenario elements such as time and place. Based on the potential risk of event risk situation to further mining association, realize self-learning event risk knowledge base, will be based on the above risks associated inference rules as the apriori algorithm of association rules mining conditions, the potential relationship between data items in the database to risk events situation elements for the index of association rule mining. The apriori algorithm, selectable to realize the classification process of the present invention, is an association rule mining algorithm. Its technical idea is to derive other high-frequency data item sets from known high-frequency data item sets. According to the association rules between data items, according to the occurrence of some items in a risk-transfer, it can be deduced that other items also appear in the same risk-transfer. The risk-transfer captured by the selected apriori algorithm can correspond to the situational and/or contextual elements and physical factors of risk events, i.e. time, place, etc. The data items defined can be corresponding to risk sources in risk events, i.e., the risk association inference rules mentioned above are indexed by risk event situation elements and are thus introduced. Taking the case data of risk events over the years as the data basis, the apriori algorithm can be used to deeply explore the potential correlation between risk sources in the context of specific measured risk events. The basic definition of mining association rules can e.g. comprise two threshold values defining a minimum and a minimum confidences to generate the reliability and availability of the rules. If the support of the rule is greater than the minimum support, the rule can be considered to be a frequent item set, otherwise it is an infrequent item set. The purpose of association rule mining is to mine from the database a strong association rule that satisfies the minimum support and the minimum credibility and the degree of action is greater than 1. The selected apriori algorithm can be applied to import data and then adapted to capture and thus realize risk correlation analysis and mining of all data. Because of the line-of-business link, process and operation are relatively complex and constantly changing, which makes the risk factor having more or less correlation between features' parameters.

It can be concluded from the above said, that risks typically do not exist independently, and that there is normally a close correlation between hidden impacts and risk factors. However, applying the above process step for automated identification and classification of risk classes or cohorts 10023 of risk-transfers 10022 in the portfolio 10021, provides a machine-based, precise, technical approach. Based on the above discussed, applied multi-step process, a risk ontology model structure can be generated. Firstly, the core of the line-of-business risks is analyzed, and the concepts of risks are formed. Then the risk classes and risk characteristics in the line-of-business risk ontology model structure are expanded in turn until the appropriate risk class and risk characteristics for the ontology model structure are obtained. Then, according to detected relationships and characteristics, subordinate relationships between the risk classes and the risk characteristics and the constraint condition of the risk classes itself are determined by the system. This allows to construct the technically applicable risk ontology model structure. Finally, taking the risk event associated with the exposure of the real-world object, the feasibility of applying the risk ontology model structure for analysis can be verified. The risk ontology and risk characteristics in the risk ontology model structure automatedly constructed and generated by the inventive system allow to select the representative, technically relevant risk factors based on threshold values for the ontology construction.

The processing steps can e.g. comprise providing, for assessing the relative risk measure, a rule-based risk parameter capturing using a preselected set of risk questions 100233. The set of risk questions 100233 can be assessed by an underwriter 13 of the risk-transfer 100221 to be added or benchmarked via a graphical user interface and each response value of the underwriter 13 to a question of the set of questions 100233 is weighted by the system 1 based on to the newly to be added or benchmarked risk-transfer 100221. The weighted response values and/or the rule-based captured risk parameters is assigned to the risk characteristics parameter values 100220. For example, the risk characteristics parameter values 100220 can be characteristic for each risk class or cohort 10023. Each specific risk class or cohort 10023 have a dedicated set of risk questions assigned based on the risk characteristics parameter values 100220 characteristic for said specific risk class or cohort 10023. To each dedicated set of risk questions 100233, predefined responses 100234 can e.g. be provided, wherein upon selection of the predefined responses 100234 the risk assessment is processed, i.e. each question set provides predefined responses per each question. Per class or cohort 10023, the set of risk questions 100233 can e.g. comprise a restricted number of questions. The set of risk questions 100233 can e.g. be limited to a number from 8 to 12 per class or cohort 10023. The risk score value 1002211 can e.g. be generated based on the weighted responses to the set of risk questions 100233 of the risk class or cohort 10023, wherein the risk score value is normed to score ranges from 0.1 to 5.0 split into 5 segments indicative of the risk quintiles 1002212, and wherein the lower the score value the higher the risk measure. A risk score value 1002211 can e.g. be measurable within a quintile 1002212 from the lower value range of the quantile 1002212 to the higher end value range.

The processing steps can e.g. further comprise generating a preliminary risk score measure 1002212 measuring and indexing a risk quality quintile based on the rule-based captured risk parameters. Each risk quality quintile representing a range of risk quality scores transformable into base rate modifiers for automated pricing;

(C) Assessing a relative risk measure 1002211 based on the actual risk exposure associated with the newly to be added risk-transfer 100221. The relative risk measure 1002211 measures the association between the total risk exposure and an actual portfolio-specific outcome upon adding the new risk-transfer 100221.

A preliminary risk score measure measuring and indexing a risk quality quintile can e.g. be generated based on the rule-based captured risk parameters, each risk quality quintile representing a range of risk quality scores transformable into base rate modifiers for automated pricing. The five risk quality quintiles can e.g. represent quality ranges of the qualities “excellent”, “good”, “average”, “fair”, and “poor”. The quality quintile indicating the quality “excellent” can e.g. comprise a noise level associated with each quality range at the value of 0.2 of a density distribution normed to 1 and/or at a standard score measure at a value of approximately ±σ˜0.1. The quintile 1002212 “average” can e.g. be indicative of the averaged expected risk quality value within a class or cohort 10023, which is reflected in the base rate assigned to the respective group or cohort 10023.

As an embodiment variant, the system 1 can e.g. comprise the two additional processing steps: (i) matching the new risk-transfer 100221 to be added or benchmarked with risk-transfers of the portfolio 10021 or historical risk-transfers 10024, wherein a risk-transfer is detected as comparable 100222, if its risk characteristics parameters 100220 are within a defined similarity value range to the new risk-transfer 100221, and (ii) providing access to an underwriter 13 of the risk-transfer 100221 to be added, wherein upon detection and selection of a comparable 100222, the risk-transfer 100221 to be added is matched and benchmarked against the selected comparable 100222. Further, as an additional processing step of assigning trigger parameters defining a range of risk characteristics parameter 100220, the comparables 100222 can e.g. be selected from the portfolio 10021 and/or from other conducted risk-transfers 10024 based on the assigned trigger parameters wherein only risk from the same class or cohort are compared are triggered by the assigned trigger parameters. The comparables 100222 can e.g. be matched and selected based on the following parameters: (i) class or cohort 10023, (ii) similarity of size, (iii) total turnover for CAS lines, (iv) single Total Insurable Value (TIV) for Property Recovery (PR), (v) for Property Recovery (PR), similarity of construction type and protection level, (vi) optional for Property Recovery (PR) the geographic location and/or state, wherein for Property Recovery (PR), in case of multi-location access, the location with the highest Total Insurable Value (TIV). The similarity value can e.g. range of size for selecting or triggering comparables 100222 is ±15% of the size of the risk-transfer 100221 to be matched. The similarity of construction type and protection level can e.g. be matched based on the Construction Occupancy Protection Exposure (COPE) comprising parameters defining a set of risks providing the basis for generate pricing for a risk-transfer covering a property or construction. Based on the selection and matching of the comparables 100222, the system 1 can e.g. provide risk assessment information at least comprising an original score 1002211 and/or responses 100234 selected and/or modified score 1002213 as p/o benchmarking and/or risk assessment rationale.

In an embodiment variant, an additional processing step can be added by measuring a reference risk value for each specific risk classes or cohorts 10023, wherein the risk-transfer 100221 to be added or benchmarked is matched and benchmarked against the reference risk value, the benchmark being provided to the underwriter 13 of the risk-transfer 100221 to be added or benchmarked. Therefore, the reference risk values provide a list of industry and LoB specific risk features for benchmarking against comparables. The system 1 can e.g. provide a listing of risk features as defined benchmarks for selection by the underwriter 13, which either will move the risk to a lower quintile (worse) 1002212 or a higher quintile (better) 1002212. The risk-transfer 100221 to be added or benchmarked can e.g. be benchmarked against all detected comparables 100222. The UWR can base his decision moving the risk up or down on the risk scale on other risk features not listed in the system but, in this case, has to document his rationale.

As an embodiment variant, an additional processing step is added by dynamically providing, during risk assessment, an impact measure 1002212 to the individual risk's quality score 1002211 of the overall portfolio 10021.

(D) Adding the newly to be added risk-transfer 100221 to the portfolio, if the relative risk measure 1002211 is within a desired value range. For example, in additional processing steps, where one or more of the risk-transfers 100223 of the portfolio 10021 can be benchmarked, as described above, wherein upon benchmarking, the underwriter 13 is enabled by the system 1, e.g. via the GUI, to remove one or more of the benchmarked risk-transfers 100221, and where a final risk quality score value 1002211 of the risk-transfers 100223 of the portfolio 10021 is measured, the risk being allocated to a new quality quintile 1002212 or moved within the same quintile 1002212 to a higher or lower position.

As an embodiment variant, the system 1 can e.g. comprise the processing steps of: (i) identifying risk classes or cohorts 10023 in the portfolio 10021 of risk-transfers 10022/100223, the risk classes or cohorts 10023 comprising industry classes and/or sub-classes; (ii) analyzing risk classes for typical risk features; (iii) turning features into a small set of risk focused questions and pre-defined responses from which the underwriter (UWR) picks the answers; (iv) weighting questions and feeding responses into a structure generating a default risk assessment allocating the actual risk score 1002211 into a risk quality quintile 1002212; (v) benchmarking by the underwriter 13, based on experience and knowledge the actual risk against other bound risks belonging to the same risk class, the underwriter further modifying the default risk assessment leading to a different risk opinion; (vi) justifying with a rationale the modification of the default risk assessment; and (vii) using the final risk assessment as the basis for risk related base rate modifications in the pricing process.

In summary, the platform 10 provides an automated underwriting process comprising the processing steps of: (i) identifying, for each line of business or industry, risk classes with similar risk characteristics, comprising industry classes and/or sub-classes, (ii) analyzing risk classes for typical risk features, (iii) turning features into a small set of risk focused questions and pre-defined responses from which the underwriting return (UWR) picks the answers, (iv) weighting questions and feeding responses into a structure generating a default risk assessment allocating the actual risk into a risk quality quintile, (v) benchmarking by the underwriter, based on experience and knowledge the actual risk against other bound risks belonging to the same risk class, the underwriter further modifying the default risk assessment leading to a different risk opinion, (vi) justifying with a rationale the modification of the default risk assessment, and (vii) using the final risk assessment as the basis for risk related base rate modifications in the pricing process.

Further, the platform provides an automated portfolio management structure, where (i) relative portfolio underwriting (RPUW) allows to measure the performance of the portfolio and its sub-segments in financial and in risk quality terms; (ii) Targets are defined in terms of portfolio sub-segments and monitored against risk classes and expected risk quality; (iii) During risk assessment the underwriter can track the impact of each risk to the quality of his individual and the overall portfolio of his team. RPUW allows the underwriter to constantly monitor the quality of his/her book and the individual risk's impact; (iv) This RPUW approach requires additional operational and risk related key performance measures and ratios such as (a) The extent and the frequency to which the underwriter deviates from the default risk score, (b) The amount of unanswered questions and its impact on the portfolio quality, (c) The average risk quality per industry sub-segment compared against the financial performance, and (d) Connecting risk questions with actual claims experience by including loss cause to claims reporting; (v) Risk questions, predefined responses and weightings are subject to frequent validation based on actual financial performance of individual industry classes.

Thus, the Relative Portfolio Underwriting (RPUW) process, as used herein, allows to provide qualitative assessment and analysis and places the emphasis of underwriting decisions on a consistent and reliable monitored quantifier by quantitative risk measurement and assessment. While most of the UWR procedure steps are automated and standardized the assessment of individual risks requires the underwriter's knowledge and experience when estimating the quality of an individual risk and benchmarking the risk against similar risks previously written. Finally the individual risk's impact on the overall quality of the existing portfolio is measured. RPUW includes the above discussed underwriting and portfolio management process steps which are applicable to all kind of lines of business. Apart from quantitative risk measurement, risk assessment is also a technical requirement in the process step of automated underwriting where the underwriter can access appropriate data, in particular risk measuring data, and thus an understanding of a single risk which is than allocatable to risk quality levels. Based on this approach, business activities, services and products can then automatically be grouped in risk pools which exhibit similar risk features and/or measuring parameter pattern. Within these pools the quality of each individual risk can vary along certain risk features: risks can be better or worse than others or they can be considered typical and expected for the risk pool.

In order to get the noise out of the underwriter's input for assessing the risk and estimating risk quality, the inventive system and platform introduces a new, structured and technically consistent assessment and measuring approach. To acquire the necessary underwrite-specific input and boundary condition parameter values, an underwriter can e.g. be guided by a rule-based dynamic interface through a set of risk questions which user, for example, may complete by ticking predefined responses. Each question is weighted. At the end of this process a preliminary risk score is generated and the risk is allocated to a risk quality quintile.

In addition, an underwriter can be given the freedom to apply his professional knowledge and experience, possibly not yet or not yet enough addressed in the question sets provided by over the interface. The system provides the underwriter access to similar risks (so-called comparables) underwritten in the past against which he/she can benchmark the risk he is actually underwriting. The single risk is not benchmarked against a “reference risk” but against each of the comparables. The comparables are selected from the existing portfolio of bound or quoted deals by applying certain parameters to ensure risk from the same risk group are compared. Any decision made by the underwriter during benchmarking that changes the risk quality score originally deriving from the risk question set must be substantiated. After completion of the benchmarking a final risk quality score is set and the risk is allocated to a new quintile or moved within the same quintile to a higher or lower position.

Each risk quality quintile (excellent, good, average, fair, poor) represents a range of risk quality scores which are transformed into base rate (or class rate in the US) modifiers for pricing purposes. It is to be noted that pricing in the US works differently. The risk scores are not directly linked with or applied to the class rates or LCMs but indirectly by providing the UWR with a range of debits or credits. The quintiles are used to give a high level definition of the risk quality. During risk assessment the underwriter is enabled to monitor the impact of the individual risk's quality score to his and/or a team's overall portfolio.

Risk measurement, risk assessment, risk quality scoring and benchmarking are executed in 2 following separate steps namely (i) Risk question set for data capturing, and (ii) benchmarking:

(i) Risk Question Set
Based on risk features which are typical for individual risk groups, dedicated risk questions are developed with pre-defined responses the underwriter is able to select when assessing the risk.
The risk groups are classified either by applying internal risk codes (e.g. PIC for property risks) or external industry codes, e.g. NAICS for US GL and WC risks or GDV classification for EMEA GL and EL risks.
For property underwriting the question sets have been developed per PIC3 codes.
For GL and WC/EL risks we grouped more granular risk classes to high level industry groups, e.g. manufacturing, education, recreation etc. This decision has been made to address the lack in granular risk information provided in the broker submissions. There are a few reasons for this including to avoid developing 500 question sets and responses for each NAICS code and the fact that at this level most industry codes of the same category show the same or similar features. However, as a variant, question sets can be developed for more specific industry segments (e.g. food manufacturing), e.g. based on access to 3rd party risk data or an automated solution in place to scrape the company websites and other industry and risk related data resources.
Per each industry group, between 8 and 12 questions can be developed and per each question 2 to 5 pre-defined responses. By ticking the responses the underwriters are walked through the risk assessment process. To each response a value is assigned. The question are weighted.
With the weighted values of the responses a risk quality score is calculated. The scores range from 0.1 to 5.0 split into 5 segments representing the risk quintiles. The lower the score the worse the risk. Within a quintile a risk can be on the lower or higher end.
Although there is one quintile called “average” this doesn't represent a reference point but rather the risk quality the underwriter would expect in the industry group and which at the end is also reflected in the base rate for the respective industry group.

(ii) Benchmarking
This step in risk assessment allows the underwriter 13 to compare the actual risk been underwritten against similar risks in his portfolio he had underwritten before. These other risks are called “comparables”, herein.
Comparables can e.g. be selected by using the following parameters:
   Industry class (all LoBs)
   Similar size (+/−15%)
   total turnover for CAS lines
   single location TIV for PR
   For PR same construction type and protection level (COPE elements)
   For US PR the location state (in order to address regulatory environment)
   For PR—in case of multi-location accounts the location with the highest TIV drives the selection.
A more restricted solution for selecting comparables can e.g. comprise:
   Industry class (high level only: for PR PIC2 level, for CAS NAICS 2 level)
   Total revenue for CAS and account TIV for PR along 3 bands of values which differ per LoB
The comparables provide the risk assessment information, i.e. original score, responses selected, modified score as p/o benchmarking, risk assessment rationale.
When benchmarking the actual risk against comparables the underwriter 13 can e.g. either put more emphasis on certain risk features already reflected in the questions or consider additional risk features not yet addressed, e.g. product recall plan in place for GL. A list of risk features (so-called Benchmarks) which will move the risk to a lower risk quintile (worse) or higher quintile (better) will be shown to the underwriters on the screen when hovering over the borderlines between the quintiles. However the underwriter 13 can also apply his own knowledge he gained for the specific insured, e.g. previous UW activities, media reports, most recent changes to the risk.
In all cases where the underwriter 13 moves the risk into another quintile or to the bottom or top of the same quintile the underwriter is required to provide a rationale for his decision.
The actual risk is benchmarked against all comparables and not against a “reference” or “average” risk. n “average” or neutral reference point.

In particular, the inventive system and process can be realized as a part of a digital platform providing standardized model-based relative portfolio underwriting. The invention concerns the core of a new way of automated underwriting which is referred above as “relative portfolio underwriting” (RPUW). The invention aims to tackle the challenges and deficiencies of the prior art systems as noise and bias in the underwriting process, thereby making the used methods of automated underwriting more effective. In particular, the standardized model-based relative portfolio underwriting aims to provide a more efficient, reliable, better priced experience by unlocking a better, more transparent end-to-end way of doing underwriting, so that underwriter and/or insurer will experience a step-change in quality of experience. The risk of an insurer and the risk of a consumer (insured) can be defined in different ways. However, there are two important measures characterizing a risk and in particular a portfolio of risks, i.e. the absolute and the relative risk measure. Regarding the relative risk measure, the average loss per exposure unit in the pool or portfolio becomes arbitrarily close to the true mean of the loss distribution with the probability approaching 1 as the number of exposure units goes against infinity. Thus, any definition of a relative risk measure has the property that it goes to zero as the number of exposure units goes to infinity, i.e. the relative risk becomes neglectable in large pools. In other words, the relative risk depends on the size, the characteristics and the composition of the risks and the portfolio and therefore the relative risk can be optimized as a relevant measure in the underwriting process. The core of the invention Relative Portfolio Underwriting relates to model-based relative portfolio underwriting where the carrier or underwriter is able to transparently and dynamically adapt and optimize the relative risk in relation to the proposed pricing during the portfolio underwriting process.

It is important to provide a precise and transparent risk measure since a possible measure for a reduction of the risk through appropriate pooling in a portfolio is sensitive to the used risk definition. Typically, risk can be reduced in the relative but not the absolute sense as e.g. the pool grows or its composition is amended. The discussed results for relative risk measures do not necessarily be applicable for absolute risk measures, since the absolute risk can e.g. become large respectively infinite as the size of the portfolio or pool goes against infinity, i.e. the absolute risk does not necessarily tend to disappear e.g. in large pools.

The system provides automated risk assessment and measuring and exposure signaling of associated, risk-event-driven or risk-event-triggered systems, such as risk-transfer systems and/or insurance systems; in particular, automated risk-transfer transferring risks of catastrophic or operational or other risk-events with different frequency structure. The system is applicable to any occurrence structures, for example low or high statistic events that also may have an occurrence rate with a various clustering structure. Occurring risk-events are measured by means of measuring stations or sensors in loco and/or by satellite image processing. The measured sensory data of the measuring devices are transmitted via an appropriate data transmission network to a central core circuit and can be assigned to a historic event set comprising event parameters for each assigned risk-event. To capture and measure the appropriate measured sensory data the central core circuit comprises a risk-event driven core aggregator with measuring data-driven triggers for triggering, capturing, and monitoring in the data flow pathway of the sensors and/or measuring devices of the risk-exposed units or individuals. The sensors and/or measuring devices can, e.g., comprise at least seismometers or seismographs for measuring any ground motion, including seismic waves generated by earthquakes, volcanic eruptions, and other seismic sources, stream gauges in key locations across a specified region, measuring during times of flooding how high the water has risen above the gauges to determine flood levels, measuring devices for establishing wind strength, e.g. according to the Saffir-Simpson Scale, sensors for barometric pressure measurements and/or ocean temperature measurements, in particular the temperatures of ocean surface waters and thereby determining the direction a hurricane will travel and a potential hurricane's intensity (e.g., by means of floating buoys to determine the water temperature and radio transmissions back to a central system), and/or satellite image measurements estimating hurricane strength by comparing the images with physical characteristics of the hurricane. The central core circuit further comprises a trigger-driven score module measuring and/or generating a single or a compound set of variable scoring parameters of a hazard, i.e. measuring parameters of an occurring hazard risk-event profiling the occurrence and/or style and/or environmental condition of a hazard based upon the triggered, captured, and monitored measuring parameters or environmental parameters.

Finally, the additional processing step of generating a preliminary risk score measure measuring and indexing a risk quality quintile based on the rule-based captured risk parameters, wherein each risk quality quintile represents a range of risk quality scores transformable into base rate modifiers for automated pricing, can e.g. comprise an automated optimization of the set of rule-based captured risk parameters by applying a machine-learning structure, for example, based on (1) standard logistic regression; (2) logistic regression with elastic-net regularization; (3) Naive Bayes; (4) K-Nearest Neighbors (KNN); (5) Support Vector Machine with polynomial kernel; (6) Support Vector Machine with gaussian kernel; (7) Deep Neural Network; (8) Random forest; or (9) Gradient Boosting Machine. For the training phase, a randomly taken set of risk events can be taken as the in-sample training set, while the other measured cases can e.g. be allocated as out-of-sample data. The smaller set can e.g. be used as training data to better simulate a real-world decision-making scenario in which impacting risk-events can be minimized. For each training set, a multi-fold cross-validation can e.g. be applied to search for the best combination of hyperparameters for the respective model, wherein the decision function is applied with the optimal hyperparameters on the remaining measured risk events. The neural network structure can e.g. follow a feedforward architecture trained using a stochastic gradient descent algorithm, with dropout layers after each of the dense layers, before using the output as activation functions. The hyperparameters that can e.g. be tuned for the selected model during the validation step. In order to strengthen the robustness of the results, the training-validation-test procedure can be repeated a plurality times, randomly selecting different measured risk events for the training and test sets on each evaluation round. Finally, a further model-agnostic artificial intelligence structure can be applied to automatically estimate and simulate the relative importance of each feature using a permutation-based approach and to perform a local analysis on the prominent risk events frequently classified as false positive and false negative for the best-performing models using e.g. Shapley Additive Explanation.

As a final remark, it has again to be noted, that one of the cores of inventive approach lies in the measurement and assessment of the “comparables” as quantitative measure: (i) The invention allows to provide an automated relative portfolio underwriting based on comparables is an integral part of the automation; (ii) The use of the comparables technically allow to provide a list of historic submissions with similar characteristics for reference; (iii) The comparables are heavily dependent on amount of production data that the system is able to measure/collect/access in order to get a match based on defined rules; (iv) Depending on the granular level of the rules it can take a considerable amount of time to get decent number of comparables for each incoming submission; (v) On the other hand, having to broadly defined rules will result in identifying comparables which truly do not represent similar risk characteristics; and (vi) Regarding the measured comparables, the inventive system provides a balanced approach which provides an optimized approach to the technical task of the present automation.

List of reference signs

```
  1 Automated system
    10 Automated UW Portal
      100 Portfolio Manager
        1001 Core engine
          10011 Signaling module
        1002 Persistence storage
          10021 Portfolio 1, . . . , i
            1002211 Risk Quality Score
            1002212 Quality Quintile
          10022 Risk-transfers structures
            100220 Risk Characteristics Parameters
            100221 Risk-Transfer to be Added or
              Benchmarked
              1002211 Relative Risk measure of
RT
              1002212 Impact Measure to the
                Risk Quality Score of Portfolio
              1002213 Modified Risk Quality
Score
            100222 Comparables to Risk-Transfer
100221
            100223 Risk-transfers 1, . . . , x of Portfolio i
          10023 Risk Classes or Cohorts of the Portfolios
            100231 Risk Parameter Value Range
            100232 Risk Exposure Parameter Range
            100233 Dedicated Set of Risk Questions
            100234 Predefined Response Possibilities
            100235 Weights to the Set of Risk
Questions
          10024 Historic risk-transfers
      101 Relative Risk Measuring and Assessment module
        1011 Distribution generator
        1012 Estimated or predefined distribution
          10121 Generalized Pareto Distribution (GPD)
          10122 Gamma function
      103 Comparables Matching and Detection module
    11 Network
    12 Network Client with UW Portal Access
    13 Underwriter
```

1. An automated underwriting method for an automated underwriting platform capturing line of business risks based on relative risk measurements using a portfolio that includes is a container capturing a plurality risk-transfers interlinked by a mutual relationship provided by the portfolio where each risk-transfer captures at least a part of a risk associated with an underwriter, the method comprising:
identifying risk classes or cohorts of the risk-transfers in the portfolio, each of the risk classes or cohorts of the portfolio including risk-transfers having defined risk characteristics parameter values in a class-specific risk parameter value range associated with the risk class or cohort, and each of the risk classes or cohorts of the portfolio being associated with a class-specific risk exposure parameter range,
detecting and assigning, for a new risk-transfer to be added to the portfolio, a risk class or risk cohort of the portfolio by triggering the risk class or risk cohort based on the risk characteristics parameter values of the risk-transfer to be added, the risk characteristics parameter values of the risk-transfer being in the class-specific risk exposure parameter range of the triggered risk class or risk cohort,
assessing a relative risk measure based on an actual risk exposure associated with the newly to be added risk-transfer, the relative risk measure measuring an association between a total risk exposure and an actual portfolio-specific outcome upon adding the new risk-transfer,
providing, for assessing the relative risk measure, a rule-based risk parameter capturing using a preselected set of risk questions, wherein the set of risk questions is assessed by an underwriter of the risk-transfer newly to be added or benchmarked via a graphical user interface and each response value of the underwriter to a question of the set of questions is weighted based on to the newly to be added or benchmarked risk-transfer, the weighted response values and/or the rule-based captured risk parameters being assigned to the risk characteristics parameter values,
generating a preliminary risk score measure measuring and indexing a risk quality quintile based on the rule-based captured risk parameters, each risk quality quintile representing a range of risk quality scores transformable into base rate modifiers for automated pricing including an automated optimization of the set of rule-based captured risk parameters by applying a machine-learning structure trained using a randomly taken set of risk events as an in-sample training set, and
adding the newly to be added risk-transfer to the portfolio if the relative risk measure is within a desired value range.

2. The method according to claim 1, wherein the five risk quality quintiles represent quality ranges of the qualities excellent, good, average, fair, and poor.

3. The method according to claim 2, wherein the quality quintile indicating the quality excellent includes a noise level associated with each quality range at the value of 0.2 of a density distribution normed to 1 and/or at a standard score measure at a value of approximately ±σ˜0.1.

4. The method according to claim 1, further comprising:
matching the risk-transfer newly to be added or benchmarked with the risk-transfers of the portfolio or historical risk-transfers, wherein a risk-transfer is detected as comparable if its risk characteristics parameters are within a defined similarity value range to the new risk-transfer, and
providing access to an underwriter of the risk-transfer newly to be added, wherein upon detection and selection of a comparable, the risk-transfer newly to be added is matched and benchmarked against the selected comparable.

5. The method according to claim 4, further comprising assigning trigger parameters defining a range of the risk characteristics parameters, wherein
the comparables are selected from the portfolio and/or from other conducted risk-transfers based on the assigned trigger parameters, and
only risk from a same class or cohort that are compared are triggered by the assigned trigger parameters.

6. The method according to claim 2, further comprising:
matching the risk-transfer newly to be added or benchmarked with the risk-transfers of the portfolio or historical risk-transfers, wherein a risk-transfer is detected as comparable if its risk characteristics parameters are within a defined similarity value range to the new risk-transfer,
providing access to an underwriter of the risk-transfer newly to be added, wherein upon detection and selection of a comparable, the risk-transfer newly to be added is matched and benchmarked against the selected comparable, upon benchmarking, the underwriter being enabled to remove one or more of the benchmarked risk-transfers, and
measuring a resulting risk quality score value of the risk-transfers of the portfolio, the risk being allocated to a new quality quintile or moved within the same quintile to a higher or lower position.

7. The method according to claim 1, further comprising measuring a reference risk value for each specific risk classes or cohorts, wherein
the risk-transfer newly to be added or benchmarked is matched and benchmarked against the reference risk value, and
the benchmark is provided to the underwriter of the risk-transfer to be added or benchmarked.

8. The method according to claim 1, further comprising dynamically providing, during risk assessment, an impact measure of an individual risk quality score to the portfolio.

9. The method according to claim 1, wherein
the risk characteristics parameter values are characteristic for each risk class or cohort, and
each specific risk class or cohort have a dedicated set of risk questions assigned based on the risk characteristics parameter values characteristic for said specific risk class or cohort.

10. The method according to claim 9, wherein
predefined responses are provided to each dedicated set of risk questions, and
upon selection of the predefined responses the risk assessment is processed.

11. The method according to claim 1, wherein the risk classes or cohorts are automatically classified by applying internal risk codes and/or external industry codes.

12. The method according to claim 11, wherein the applied internal risk codes at least include Property Industry Code (PIC) risk identification for property risks.

13. The method according to claim 11, wherein the external industry codes at least include North American Industry Classification System (NAICS) and/or German Insurance Association (GDV) classification.

14. The method according to claim 1, wherein in a case of detecting a lack in granular risk information provided by captured risk characteristics parameter values, more granular risk classes or cohorts are automatically grouped high level groups or cohorts.

15. The method according to claim 1, wherein the set of risk questions include a limited number of questions per class or cohort.

16. The method according to claim 15, wherein the set of risk questions is limited to a number from 8 to 12 per class or cohort.

17. The method according to claim 1, wherein
the risk score value is generated based on the weighted responses to the set of risk questions of the risk class or cohort,
the risk score value is normed to score ranges from 0.1 to 5.0 split into 5 segments indicative of the risk quintiles, and
the lower the score value the higher the risk measure.

18. The method according to claim 17, wherein a risk score value is measurable within a quintile from the lower value range of the quantile to the higher end value range.

19. The method according to claim 2, wherein the quintile average is indicative of an averaged expected risk quality value within a class or cohort, which is reflected in the base rate assigned to the respective class or cohort.

20. The method according to claim 4, wherein the comparables are matched and selected based on the following parameters:
(i) class or cohort,
(ii) similarity of size,
(iii) total turnover for CAS lines,
(iv) single Total Insurable Value for Property Recovery,
(v) for Property Recovery, similarity of construction type and protection level,
(vi) for Property Recovery, the geographic location and/or state, and
(vii) for Property Recovery, in case of multi-location access, the location with the highest Total Insurable Value.

21. The method according to claim 20, wherein the similarity value range of size for selecting or triggering comparables is ±15% of the size of the risk-transfer to be matched.

22. The method according to claim 20, wherein the similarity of construction type and protection level is matched based on the Construction Occupancy Protection Exposure comprising parameters defining a set of risks providing the basis for generate pricing for a risk-transfer covering a property or construction.

23. The method according to claim 4, further comprising providing risk assessment information at least including an original score and/or responses selected and/or modified score as p/o benchmarking and/or risk assessment rationale.

24. The method according to claim 1, further comprising providing a listing of risk features as defined benchmarks for selection by the underwriter, which either will move the risk to a lower quintile or a higher quintile.

25. The method according to claim 4, wherein the risk-transfer newly to be added or benchmarked is benchmarked against all detected comparables.

26. The method according to claim 1, further comprising:
identifying industry classes and/or sub-classes in the portfolio of risk-transfers,
analyzing risk classes for typical risk features,
turning features into a small set of risk focused questions and pre-defined responses from which an underwriting return picksanswers,
weighting questions and feeding responses into a structure generating a default risk assessment allocating an actual risk score into a risk quality quintile,
benchmarking by the underwriter, based on experience and knowledge the actual risk against other bound risks belonging to the same risk class, the underwriter further modifying a default risk assessment leading to a different risk opinion,
justifying with a rationale the modification of the default risk assessment, and
using a final risk assessment as a basis for risk related base rate modifications in a pricing process.

27. The method according to claim 1, wherein the line of business risks at least include general liability and/or professional liability risks and/or worker compensation and/or employers' liability and/or property risks.
